(19) United States
(12) Patent Application Publication
(10) Pub. No.: US 2026/0186982 A1
(43) Pub. Date: Jul. 2, 2026

(54) METADATA FOR INDICATION OF ACCESS AUTHORIZATION IN A MEMORY SYSTEM

(71) Applicant: Micron Technology, Inc., Boise, ID (US)

(72) Inventors: Lance W. Dover, Fair Oaks, CA (US); Frank F. Ross, Boise, ID (US); Scott E. Schaefer, Boise, ID (US); Sujeet V. Ayyapureddi, Boise, ID (US); Randall J. Rooney, Boise, ID (US); Navid Lashkarian, Pleasanton, CA (US); Matthew A. Prather, Boise, ID (US)

(21) Appl. No.: 19/426,148

(22) Filed: Dec. 19, 2025

Related U.S. Application Data
(60) Provisional application No. 63/740,073, filed on Dec. 30, 2024.

(51) Int. Cl. G06F 12/14

(52) U.S. Cl. CPC G06F 12/1441; G06F 12/1408; G06F 12/1458

(57) ABSTRACT

Methods, systems, and devices for metadata for indication of access authorization in a memory system are described. Some memory systems may not permit access to data stored within the memory system by a host system until the host system and corresponding access request are verified. If a host system attempts to access the memory system and is not verified, the memory system described herein may send invalid data or poisoned data back to the host system in addition to metadata that indicates that the host system was not verified to access the memory system. The metadata may include multiple bits associated with multiple candidate values. At least one value of the multiple candidate values may be reserved for indicating that an access request was denied due to a failed verification of the host system. The host system may use the metadata to improve subsequent access requests.

### CROSS REFERENCE

The present Application for Patent claims priority to U.S. patent application Ser. No. 63/740,073 by Dover et al., entitled “METADATA FOR INDICATION OF ACCESS AUTHORIZATION IN A MEMORY SYSTEM,” filed Dec. 30, 2024, which is assigned to the assignee hereof, and which is expressly incorporated by reference in its entirety herein.

### TECHNICAL FIELD

The following relates to one or more systems for memory, including metadata for indication of access authorization in a memory system.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports metadata for indication of access authorization in a memory system in accordance with examples as disclosed herein.

FIG. 2 shows an example of a system that supports metadata for indication of access authorization in a memory system in accordance with examples as disclosed herein.

FIG. 3 shows an example of a process flow that supports metadata for indication of access authorization in a memory system in accordance with examples as disclosed herein.

FIG. 4 shows a block diagram of a memory system that supports metadata for indication of access authorization in a memory system in accordance with examples as disclosed herein.

FIG. 5 shows a flowchart illustrating a method or methods that support metadata for indication of access authorization in a memory system in accordance with examples as disclosed herein.

### DETAILED DESCRIPTION

Some memory systems may improve security by using access control techniques (e.g., validation or verification) to verify accesses to the memory system. For example, a memory system may improve security by validating that a host is an authorized user of the system before granting access to the host system. The memory system may support a relatively limited functionality, such as a read-only functionality, before granting access based on verifying a host. The memory system may share, after power up, during manufacture, or within some other initialization duration, one or more shared values (e.g., a secret key) with the host system. The one or more shared values may enable the host system to generate an encrypted or otherwise randomized value, which can later be sent to the memory system for verification. The one or more shared values may be sent to the host system and stored by the memory system on a per-region or per data type basis (e.g., per address range, per type of data stored by the memory system), in some examples. If the memory system receives an invalid access request that fails a verification procedure by the memory system, the memory system may send invalid data that is either random data or poisoned data back to the requesting host system. The host system may not know how to process the data or modify subsequent host requests for successful validation. Additionally, the memory system may access the data stored within the memory arrays to verify the data, which may increase processing and latency.

Techniques, systems, apparatuses, and devices are described herein for a memory system to perform a verification procedure with a host system based on initialization, in response to an access request received from the host system, or both, and then send, to the host system, metadata that indicates if the verification procedure failed. The verification procedure may be specific to a certain region (e.g., address range), a certain type of data, or both. If the host system is not authorized to access the region of data, the metadata may indicate why the host does not have access to the region of data. Additionally, or alternatively, the metadata may indicate whether corresponding data sent to the host system is randomized or poisoned data. The memory system and the host system may each store one or more shared values based on an initial authorization process. Any access command received by the memory system may include a type of access value (e.g., a key, digital sequence, authorization code, or the like) that is generated based on the shared values. The memory system may generate an authorization code based on the one or more shared values and use the authorization code to verify the access value in each access command.

The memory system may generate metadata based on the verification failing. The metadata may include multiple bits each associated with a respective state. At least one of the states may be reserved to indicate that access is not authorized, the corresponding data is poisoned, the host used an incorrect access key, or the like. The metadata may be retrieved from one or more memory arrays within the memory system, or from a location external to the memory arrays (e.g., to improve reliability). The verification and metadata generation may be performed by a system-level component within the memory system, in some examples. The system-level component may generate and send the metadata along with some invalid data without accessing the one or more memory arrays. For example, the system-level error correction component may determine an access command is invalid and send some fixed or otherwise defined set of invalid data instead of accessing the requested data, which may reduce processing and latency as compared with techniques in which the memory arrays are accessed. The requesting host system may thereby receive metadata that provides an indication of why the host system was not authorized to access the data, which may improve subsequent operations by the host system, among other examples.

In addition to applicability in memory systems as described herein, techniques for using metadata to indicate access authorization may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by reducing latency and processing overhead when an access request is invalid by refraining from accessing one or more arrays within the device, which may decrease processing and latency times, improve response times, and otherwise improve user experience, among other benefits.

In addition to applicability in memory systems described herein, techniques for using metadata to indicate access authorization may be generally implemented to improve security and/or authentication features of various electronic devices and systems. As the use of electronic devices for handling private, user, or other sensitive information has become even more widespread, electronic devices and systems have become the target of increasingly frequent and sophisticated attacks. Further, unauthorized access or modification of data in security-critical devices such as vehicles, healthcare devices, and others may be especially concerning. Implementing the techniques described herein may improve the security of electronic devices and systems by performing access control techniques and providing invalid data to unauthorized accessors and may prevent or mitigate unauthorized access to data or other information, use less power relative to other solutions, and provide increased information to the associated host system, among other benefits.

Features of the disclosure are illustrated and described in the context of systems and architectures. Features of the disclosure are further illustrated and described in the context of a process flow and flowcharts.

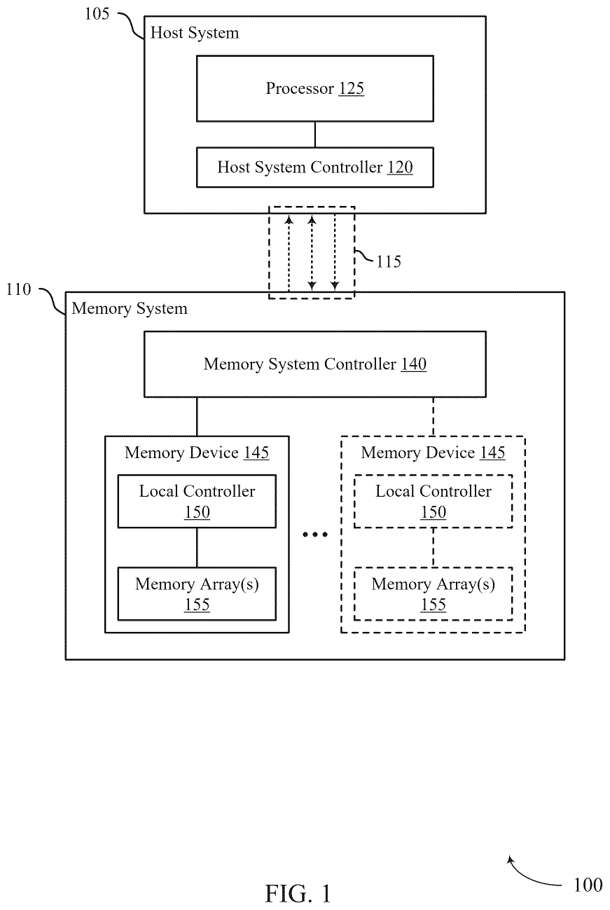

FIG. 1 shows an example of a system 100 that supports metadata for indication of access authorization in a memory system in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

A host system 105 may include one or more components (e.g., circuitry, processing circuitry, application processing circuitry, one or more processing components) that use memory to execute processes (e.g., applications, functions, computations), any one or more of which may be referred to as or be included in a processor 125 (e.g., an application processor). A processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. A processor 125 may be an example of a central processing unit (CPU), a graphics processing unit (GPU), a general-purpose GPU (GPGPU), or an SoC or a component thereof, among other examples.

A host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating a memory system 110, such as write commands, read commands, configuration signaling or other operational signaling. In some examples, a host system controller 120, or associated functions described herein, may be implemented by or be part of a processor 125. For example, a host system controller 120 may be hardware, instructions (e.g., software, firmware), or a combination thereof implemented by a processor 125 or other component of a host system 105. In various examples, a host system 105 or a host system controller 120 may be referred to as a host.

A memory system 110 provides physical memory locations (e.g., addresses) that may be used or referenced by the system 100. A memory system 110 may include a memory system controller 140 and one or more memory devices 145 (e.g., memory packages, memory dies, portions of a memory die) operable to store data. A memory system 110 may be configurable for operations with different types of host systems 105, and may respond to commands from the host system 105 (e.g., from a host system controller 120). For example, a memory system 110 (e.g., a memory system controller 140) may receive a write command indicating that the memory system 110 is to store data received from a host system 105, or receive a read command indicating that the memory system 110 is to provide data stored in a memory device 145 to a host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of a memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with a host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 (e.g., a logic controller, an interface controller, one or more processors) and one or more memory arrays 155. A memory array 155 may be a collection of memory cells (e.g., a two-dimensional array, a three-dimensional array, an array of one or more semiconductor components), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. In some implementations, at least the channels 115 between a host system 105 and a memory system 110 may include or be referred to as a host interface (e.g., a physical host interface). To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

A command/address channel (e.g., a CA channel) may be operable to communicate commands between the host system 105 and the memory system 110, including control information associated with the commands (e.g., address information, configuration information). Commands carried by a command/address channel may include a write command with an address for data to be written to the memory system 110 or a read command with an address of data to be read from the memory system 110.

A clock signal channel may be operable to communicate one or more clock signals between the host system 105 and the memory system 110. Clock signals may oscillate between a high state and a low state, and may support coordination (e.g., in time) between operations of the host system 105 and the memory system 110. In some examples, a clock signal may provide a timing reference for operations of the memory system 110. A clock signal may be referred to as a control clock signal, a command clock signal, or a system clock signal. A system clock signal may be generated by a system clock, which may include one or more hardware components (e.g., oscillators, crystals, logic gates, transistors).

A data channel (e.g., a DQ channel) may be operable to communicate (e.g., bidirectionally) information (e.g., data, control information) between the host system 105 and the memory system 110. For example, a data channel may communicate information from the host system 105 to be written to the memory system 110, or information read from the memory system 110 to the host system 105. In some examples, the data channel may support communication of different types of information based on different scenarios. For example, data may be sent in a burst according to a defined sequence, where one or more beats (e.g., segments, pulses, bits) of the burst sequence may represent data and other beats of the burst sequence may represent metadata (e.g., ECC information, or the like). In some examples, channels 115 may include one or more error detection code (EDC) channels. An EDC channel may be operable to communicate error detection signals, such as checksums or parity bits, which may accompany information conveyed over a data channel.

As described herein, the memory system 110 may perform access control and verification. That is, the memory system 110 may verify the host system 105 as an authorized user before providing the host system 105 with access to the data stored within the memory system 110. The memory system 110 may perform a verification procedure with the host system for a given region of data stored at the memory system 110. For example, an access command from the host system 105 may include an access value and the memory system 110 may generate its own authorization values to compare with the access value as part of a verification procedure. If the access command satisfies the verification procedure, the host system 105 may be an authorized user of the memory system 110, and the memory system 110 may send the requested data to the host system 105 or otherwise grant the requested access to the host system 105. In some examples, the memory system 110 may additionally transmit metadata with the requested data. The metadata may include one or more bits, and a value of the one or more metadata bits may indicate various types of information associated with the data to the host system 105.

As described herein, the metadata may be used to indicate, to the host system 105, if the host system 105 is not authorized to access the requested data. For example, if the verification procedure for a request, by the host system 105, to a given region of data within the memory system 110 fails, the memory system 110 may send bogus data to the host system 105 along with metadata that indicates that the host system 105 is not an authorized user. The metadata may thereby provide, to the host system 105, some indication of why the host system 105 is not authorized, a notification that the data sent to the host system 105 includes bogus, poisoned, or otherwise invalid data, or any combination thereof to improve subsequent operations by the host system 105.

The metadata may include multiple bits each associated with a respective state. Additionally, or alternatively, the metadata bits may be encoded as a message. For example, the bits may be combined to form a metadata value (e.g., a hex value or larger), where each metadata value is associated with a respective state. At least one of the states may be reserved to indicate that access is not authorized, the corresponding data is poisoned, the host system 105 used an incorrect access key, or the like. The metadata may be retrieved from one or more memory arrays 155 within the memory system 110, or from a location external to the memory arrays 155 (e.g., to improve reliability). The verification and metadata generation may be performed by a system-level error correction component within the memory system 110, in some examples. The system-level component may generate and send the metadata along with some invalid data without accessing the one or more memory arrays 155. For example, the system-level error correction component may determine an access command is invalid and send some fixed or otherwise defined set of invalid data instead of accessing the requested data, which may reduce processing and latency as compared with techniques in which the memory arrays 155 are accessed. The requesting host system 105 may thereby receive metadata that provides an indication of why the host system 105 was not authorized to access the data, which may improve subsequent operations by the host system 105, among other examples.

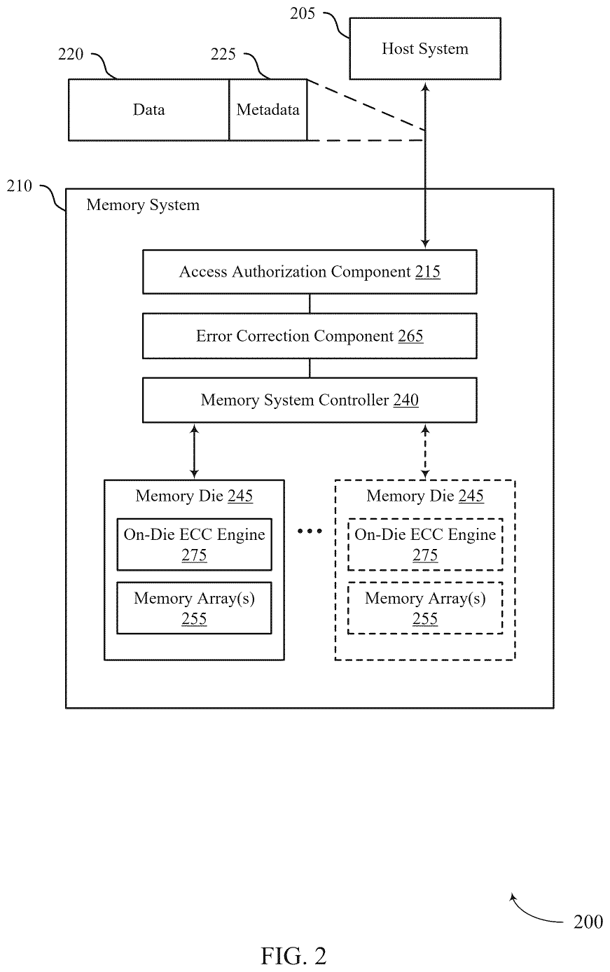

FIG. 2 illustrates an example of a system 200 that supports metadata for indication of access authorization in a memory system in accordance with examples as disclosed herein. The system 200 represent an example of a system 100 or one or more components thereof. The system 200 may include a memory system 210 that supports system-level (e.g., module-level) error correction by a system-level error correction component 265 before data is conveyed to a host system 205. The memory system 210 and the host system 205 may represent examples of corresponding systems as described herein, including with reference to FIG. 1. As described herein, the memory system 210 may transmit metadata 225 to the host system 205 to indicate if a verification procedure for the host system 205 fails, if corresponding data 220 includes invalid or poisoned data, or both.

The memory system 210 may represent an example of a module including one or more memory dies 245, which may represent examples of the memory devices 145 described with reference to FIG. 1. Each of the memory dies 245 may include one or more memory arrays 255 configured to store data, parity bits, metadata, or the like. In some examples, each of the memory dies 245 may also include a respective on-die ECC engine 275, which may represent an example of error correction circuitry configured to detect errors, correct errors, or both within the data stored to the memory arrays 255 of the memory die 245.

The memory system 210 may include or otherwise be coupled with an I/O component and a data buffer configured to facilitate the transfer of data to and from the memory system 210 via one or more channels, such as the one or more channels 115 described with reference to FIG. 1 (e.g., a link). As described herein, the memory system controller 240 may additionally include or otherwise be coupled with an access authorization component 215 that includes logic, circuitry, or both configured to perform one or more access control techniques described herein. The memory system 210 may include a memory system controller 240, which may represent an example of the memory system controller 140 as described and illustrated with reference to FIG. 1. The memory system controller 240 may facilitate or otherwise manage the operations by the access authorization component 215, the error correction component 265, and accesses to and from the one or more memory dies 245.

In this example, the memory system controller 240 may additionally include or otherwise be coupled with the error correction component 265. The error correction component 265 may support a system-level error correction functionality within the memory system 210. That is, the data may be corrected at a system level by the error correction component 265 before the data is transferred to the host system 205, which may improve performance, in some examples. For example, transferring the parity bits from one or more of the memory dies 245 configured to store parity information to the error correction component 265 may consume less power and overhead than transferring the parity bits off of the memory system 210 to the host system 205. Shipping the extra bits (e.g., 80 extra parity bits, or some other quantity) to the host system 205 may increase energy and overhead. Additionally, or alternatively, exposing the parity bits outside of the memory system 210 may pose security risks. Since the error correction component 265 is local to the memory system 210, the energy expended to move the extra bits may be less than energy to ship the bits to the host system 205, and security within the memory system 210 may be maintained.

Thus, the error correction component 265 may receive, in response to a read command, data from one or more of the memory dies 245, as well as one or more parity bits from the parity memory dies 245 (e.g., the memory dies 245 that only store parity information). The error correction component 265 may be configured to perform an error detection and correction operation on the data using the parity bits. The error detection and correction operation may be performed in accordance with one or more different algorithms or techniques. For example, the error correction component 265 may include one or more logic components configured to support (e.g., execute) error correction code (ECC), error-detecting code (EDC), other algorithms, or any combination thereof. The memory system 210 may send the corrected data to the host system 205 after the error correction is performed. In some examples, the memory system 210 may transfer one or more bits of metadata with the data to indicate that system-level error correction was performed, to indicate whether the errors were corrected or not, to indicate an address of the data, or other information associated with the data. The host system 205 may thereby receive the data with an indication of where error correction was performed, and may determine how to address any potential errors the host system 205 may detect accordingly. It may be beneficial to have all correction capability at the system level using all of the parity bits retrieved from the memory dies 245. Such system-level error correction may be performed in addition to the on-die error correction by the on-die ECC engines 275, in some examples. The memory system 210 may support dynamic and flexible error correction at both the system-level and the die-level based on values of one or more mode registers.

To support the system-level error correction, all of the data that is written to or read from any of the one or more memory dies 245 may pass through a same initial data buffer and other system-level circuitry or logic, which may provide an aggregated point for data verification in addition to the correction. Such system-level circuitry and/or logic may be expanded as described herein to include circuitry for access authorization, among other examples. For example, as illustrated in FIG. 2, the memory system 210 may include an access authorization component 215, which may be included in or otherwise coupled with the error correction component 265, the memory system controller 240, or both.

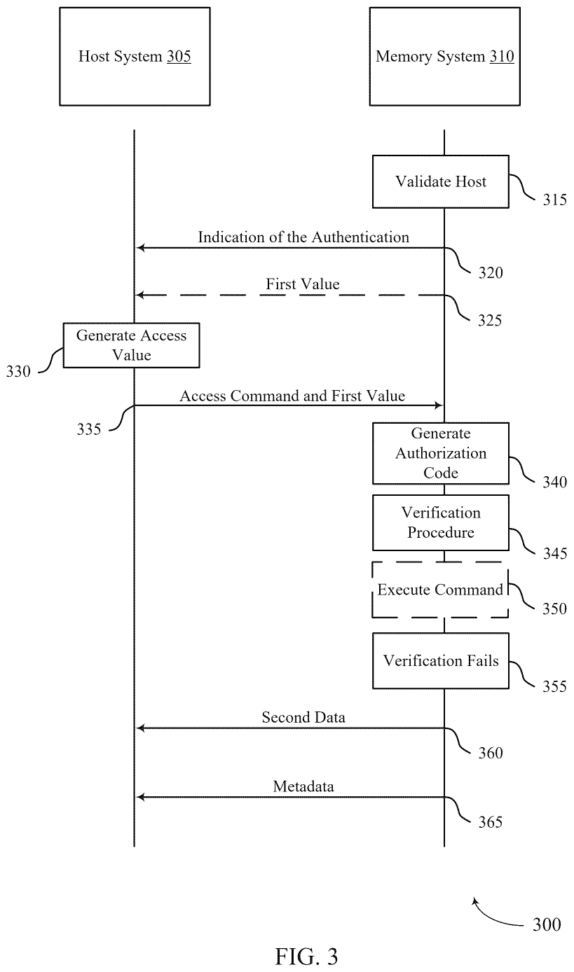

As described herein, the system-level circuitry, such as the error correction component 265, the access authorization component 215, and/or one or more other components may perform one or more verification procedures on any access commands received at the memory system 210 before the corresponding data is retrieved or error correction is performed on the corresponding data. For example, certain host systems 205 may be validated as authorized or verified users of the memory system 210 based on an authorization process, as described in further detail elsewhere herein, including with reference to FIG. 3. The memory system 210 may share one or more shared values (e.g., secret keys) with such authorized host systems 205. The shared values may be stored to one or more of the memory dies 245, within the access authorization component 215, the error correction component 265, or elsewhere in a secure location of the memory system 210.

When a host system 205 sends an access command to the memory system 210, the host system 205 may include some access value in the access command. The access value may be a key, signature, or other identifier that is at least partially based on the one or more shared values. The access authorization component 215 may receive the access command and generate a new authorization value based on the one or more shared values. The access authorization component 215 may perform a verification procedure to verify the host system 205 by comparing the generated authorization value with the access value send via the access command.

In some examples, the access value may be region-specific. That is, the access command may include the access value and a range of one or more addresses (e.g., logical block addresses) within the one or more memory dies 245 at which target data is stored. In such cases, the access authorization component 215 may verify accesses on a per-region basis. That is, one or more of the shared values may be associated with each region of the memory system 210, and the access authorization component 215 may authorize the host system 205 to access only a certain address range based on the access value matching the authorization value generated by the access authorization component 215.

Additionally, or alternatively, the access value may be specific to one or more types of data. For example, the access command may include the access value and a request or other indication for a certain type of data, including metadata, ECC data, parity data, or other types of data. In such cases, the access authorization component 215 may verify accesses per types of data. That is, one or more of the shared values may be associated with each type of data, and the access authorization component 215 may authorize the host system 205 to access only a certain type of data based on the access value matching the authorization value generated by the access authorization component 215.

If the access value included in an access request is the same as the authorization value generated by the access authorization component 215, the host system 205 may be verified, and the memory system 210 may permit the requested access. That is, the memory system 210 may write the data to the address range, read the data from the address range, or otherwise modify the indicated range of data, type of data, or both in response to the access command. In some examples, the memory system 210 may send the requested data back to the host system 205 (e.g., in response to a read command, for example). The memory system 210 may additionally, or alternatively, send metadata 225 to the host system 205 to indicate information associated with the requested data, such as ECC-related information, location information, or the like.

If the access value included in an access request does not match the authorization value generated by the access authorization component 215, the access authorization component 215 may prohibit access by the host system 205 to the requested region of data, to at least the requested type of data, or to any data in the memory system 210, in some examples. In such cases, the memory system 210 may still respond to the request, but may include data 220 that is bogus, null, poisoned, or otherwise invalid (e.g., instead of any data stored in the memory system 210). The host system 205 may receive the data 220 and may not know whether the data 220 is the requested data or not until after one or more verification operations. In some examples, the host system 205 may assume an error occurred. If the host system 205 is authorized, but improperly generated the access value, among other examples, the host system 205 may not identify the issue based on the received data 220.

Techniques described herein provide for the memory system 210 to send metadata 225 in addition to invalid data 220 when a host system 205 is not verified. The metadata 225 may include information that indicates that the data 220 is invalid, that indicates that the verification of the access command sent by the host system 205 failed, or both. In some examples, the memory system 210 may support transfer of a quantity of bits of metadata 225 in addition to (e.g., at the same time as, before, or after) corresponding data 220 to the host system 205. The bits of metadata 225 may be associated with (e.g., may be set to represent) a set of candidate values. Each value of the set of candidate values may represent a state or other information. For example, the host system 205 and the memory system 210 may support a shared definition for the metadata 225 such that a first value indicates a failed ECC operation, or the like. In such cases, one or more of the candidate values may be reserved for indicating a failed host verification. For example, a value (e.g., all zeros, or some other value) may be defined as indicating that an access key included in a most recent access request was not valid, or indicating that the data associated with the metadata is poisoned, or both.

The data 220 and the metadata 225 may be concatenated, in some examples, into a single data transfer (e.g., a same message). Additionally, or alternatively, the data 220 and the metadata 225 may be sent serially, in parallel, or using one or more other techniques. In some examples, the metadata 225 may be sent via one or more pins or channels that are separate from the data channel. The host system 205 may receive the data 220 and the metadata 225 and may determine, based on the value of the metadata 225, whether the data 220 includes valid data or not. If the metadata 225 is set to the reserved value described herein, the host system 205 may, in some examples, refrain from decoding the data 220 or may otherwise discard the data 220. Additionally, or alternatively, the host system 205 may adjust an algorithm used for generating access keys to access the memory system 210 or take one or more other actions to improve subsequent access requests.

The metadata 225 may be transmitted via one or more bits retrieved from the memory dies 245. For example, during the verification procedure, the memory system controller 240 may retrieve the metadata 225 from the memory dies 245. Additionally, or alternatively, the metadata 225 may be transmitted via one or more bits stored elsewhere in the memory system 210 (e.g., external to the one or more memory dies 245) such that the memory system 210 may perform the verification process and response without accessing the memory dies 245, which may reduce latency and processing and improve reliability, among other examples. In such cases, the memory system controller 240 and the access authorization component 215 may perform the functions associated with receiving an access command, determining the access command is not verified to access the memory system 210, and responding to the host system 205.

The memory system 210 may thereby improve coordination and communication with an associated host system 205 by conveying, via metadata 225, information that indicates whether an access attempt by the host system 205 was authorized or not, whether corresponding data 220 is valid data or not, or both.

FIG. 3 shows an example of a process flow 300 that supports metadata for indication of access authorization in a memory system in accordance with examples as disclosed herein. The process flow 300 may include a host system 305 and a memory system 310, which may be respective examples of a host system 105 and a memory system 110 as described with reference to FIG. 1 or a host system 205 and a memory system 210, as described with reference to FIG. 2. Although shown in a particular sequence or order, unless otherwise specified, the order of the processes may be modified. Thus, the illustrated examples are used as examples, and the illustrated processes may be performed in a different order, and some processes may be performed in parallel. Additionally, one or more processes may be omitted in various examples. Thus, not all processes are used in every example. Other process flows are possible. The process flow 300 illustrates examples for performing access control for a memory system and transmitting metadata that indicates if a verification procedure fails.

In some examples, the memory system 310 may operate according to a functionality in which the memory system 310 does not permit certain access to one or more users prior to authorization and verification of the user. For example, the memory system 310 may support read-only operations that allow the host system 305 to read information from the memory system 310 but refrain from allowing the host system 305 to write data to or modify data at the memory system 310. In other examples, the memory system 310 may refrain from allowing the host system 305 to perform any type of access while in the first functionality. If the host system 305 requests to access the memory system 310 before authorization, the memory system 310 may not permit the access request and may instead return invalid data in response to the request.

At 315, the memory system 310 may validate the host system 305 as an authorized user. For example, the memory system 310 and the host system 305 may share one or more shared values between each other. The shared values may be referred to as a secret key in some examples herein. The host system 305 may, for example, generate a first value and transmit the first value to the memory system 310. In some examples, generating the first value may include the host system 305 generating a nonce value (e.g., an arbitrary quantity or value that may be used once in communications with the memory system 310) and transmitting the nonce value to the memory system 310.

In some examples, the memory system 310 may then generate a second value including a random set of bits by implementing a randomization process on the first value. For example, the memory system 310 may seed the randomization process with the first value to generate the second value. The memory system 310 may then transmit the second value to the host system 305. The host system 305 may generate an encrypted value (e.g., a digital signature) based on receiving the second value from the memory system 310 and a secret associated with the host system 305 and the memory system 310. In some examples, the host system 305 may generate the encrypted value by implementing a randomization process, such as a cryptographic hash function or an algorithm, on the second value. That is, the encrypted value may be a specific type of message authentication code (e.g., a hash-based message authentication code (HMAC)) or a cipher-based message authentication code (e.g., a cipher-based message authentication code (CMAC)) that the host system 305 generates based on receiving the second value. Alternatively, the host system 305 may generate a rolling cleartext password to be validated by the memory system 310. That is, the host system 305 may generate a password according to the randomization process that shifts each time the memory system 310 transitions between power modes (e.g., turns on).

The host system 305 may transmit to the memory system 310 the encrypted value based on the host system 305 generating the encrypted value. The memory system 310 may validate the encrypted value received from the host system 305 to validate the host system 305 as an authorized user of the memory system 310. In some examples, the memory system 310 may validate the encrypted value by comparing the encrypted value with a stored value generated using a randomization process (e.g., a cryptographic hash function or an algorithm). That is, the memory system 310 may recreate the encrypted value by utilizing the randomization process on the secret key utilizing an algorithm. For example, the memory system 310 may combine an output of a pseudo-random number generator (PRNG) with the secret key stored at the memory system 310 utilizing the HMAC or CMAC algorithm to generate the stored value. Because the secret key of the memory system 310 and the host system 305 may be the same when the host system 305 is an authorized user, the output of the randomization process at the memory system 310 may match the output of the randomization process at the host system 305.

The memory system 310 may validate the host system 305 if the stored value matches the encrypted value received. Alternatively, the memory system 310 may validate the host system 305 by generating a rolling cleartext password utilizing the randomization process and comparing the generated cleartext password at the memory system 310 with the clear text password received from the host system 305. The memory system 310 may enable a functionality of the memory system 310 after validating the host system 305. For example, the memory system 310 enable some or all types of accesses (e.g., a read, write, or refresh access) while in the second functionality.

At 320, the memory system 310 may transmit an indication of the validation of the host system 305 based on validating the host system 305 as an authorized user. In some examples, the memory system 310 may indicate that the functionality is enabled and the memory system 310 is configured to perform some or all types of access operations.

The memory system 310 may thereby improve security by validating the host system 305 as an authorized user and sharing one or more shared values (e.g., secret keys) with the host system 305 to use for subsequent secure accesses.

At 325, in some examples, the memory system 310 may transmit a first value to the host system 305. In some examples, the memory system 310 may utilize a randomization process to generate the first value. For example, the memory system 310 may use a nonce value generated and sent by the host system 305 as a seed for a pseudorandom number generator (PRNG) algorithm to generate the first value. The nonce value may be an arbitrary quantity that may be used only once in a communication between the host system 305 and the memory system 310 to mitigate risks of a replay attack, or the host system 305 may generate the nonce value as a random quantity or as a pseudo-random (e.g., unpredictable) quantity. In some examples, the memory system 310 may generate the first value to include a pseudo-random quantity. For example, the memory system 310 may generate the first value as a 32-byte pseudo-random quantity based on utilizing the nonce value as the seed for the PRNG algorithm. The first value may be used for randomization of access codes for subsequent access commands, in some examples described herein.

At 330, the host system 305 may generate an access value. The access value may be associated with an identification of an access command that is to be transmitted to the memory system 310 as part of an access operation. In some examples, the memory system 310 may be susceptible to a replay attack after validating the host system 305. That is, the memory system 310 may be susceptible to an attacker maliciously or fraudulently replaying (e.g., copying) a valid access command transmitted over a physical bus coupling the memory system 310 and the host system 305 (e.g., the attacker may replay the command to modify or steal data from the memory system 310). To mitigate the risk of a replay attack occurring, the host system 305 may generate a unique value (e.g., tag, temporary key) that comprises a unique bit for each access command transmitted by the host system 305 as a way to identify that the access command is from an authorized user.

In some examples, the host system 305 may generate the access value by utilizing a randomization process. For example, the host system 305 may combine a random set of bits and the secret key and utilize the output as a seed for the randomization process (e.g., the seed may be an initial input that defines the sequence and outputs generated by the randomization process). In some examples, the host system 305 may use a randomization process that includes a linear-feedback shift register (LFSR) (e.g., a shift register whose output is based on the seed value). In other examples, the host system 305 may use a randomization process that includes an algorithm (e.g., a PRNG algorithm).

Additionally, or alternatively, the host system 305 may generate the access value that is an identification of a first access command to be transmitted to the memory system 310 by combining the first value conveyed at 325 with the shared values (e.g., secret key) to generate a seed for a randomization process and then utilizing the randomization process to generate the access value. In some examples, the memory system 310 and the host system 305 may both utilize a same randomization process and use the same seed with the randomization process to generate an output value. For example, the memory system 310 and the host system 305 may utilize an LFSR or a PRNG algorithm to generate the output value from the seed. The randomization process at the host system 305 may thus be synchronized with the memory system 310. That is, if the host system 305 is an authorized user, the output value of the randomization process at the host system 305 may match the output value of the randomization process at the memory system 310. The host system 305 and memory system 310 may generate the output value (e.g., the access value) to identify access commands transmitted by the host system 305 to the memory system 310.

At 335, the host system 305 may transmit the access command and the access value to the memory system 310 based on generating the access value using the randomized sequence of bits, the first value, or both as inputs to a randomization process. In some examples, the host system 305 may transmit the access value parallel to the access command. That is, the host system 305 may utilize unused bits in the access command sequence or unused pins in a channel (e.g., channel 115 as described with reference to FIG. 1) to communicate the access value. In other examples, the host system 305 may transmit the access value in series to the access command. That is, the host system 305 may transmit the access command before transmitting the access value.

In some examples, the access command may indicate an address range associated with data that the host system 305 is requesting to access or may indicate a type of data for the access, or both, and the access value may be associated with the address range, the type of data, or both. That is, the host system 305 may, in some examples, generate region-specific or data type-specific access values, each associated with a respective range of one or more logical block addresses and/or a respective type of data. In such cases, the randomization process for generating the access value may be based on the address range and the data type. In some examples, during the initial authorization of the host system 305, the memory system 310 and the host system 305 may share region-specific shared values, data type-specific shared values, or any combination thereof. For example, a shared value between the memory system 310 and the host system 305 may be applicable to a certain subset of address ranges within the memory system 310, but may not be applicable to other address ranges, or may be applicable to a certain type of data in the memory system 310, but may not be applicable to other data types. In such cases, the access values generated with each access command may similarly be data type-specific, region-specific, or both, and the verification procedure may fail for a certain host system 305 requesting to access a region that the host system 305 is not authorized to access, but may succeed for the same host system 305 and other regions, among other examples.

At 340, as part of a verification procedure to determine whether to permit or prohibit the requested access to the data, the memory system 310 may generate a third value, which may be referred to as an authorization code herein, by utilizing a randomization process after receiving the access value and the access command. The third value may be, for example, a verification key, an authorization code, a digital signature, or any combination thereof. In some examples, the memory system 310 may generate the authorization code to validate (e.g., verify) that the access command is from an authorized user. For example, the memory system 310 may combine the first value sent at 325 or one or more randomized values with and the secret key and may utilize the output as a seed of the randomization process. In some examples, the randomization process at the memory system 310 may be synchronized with the host system 305. That is, the memory system 310 may implement the same randomization process utilized at the host system 305 with the same seed. When the randomization process is synchronized, the memory system 310 may generate the same output (e.g., the same authorization code) because the seed utilized at the memory system 310 is the same as the host system 305 (e.g., if the host system 305 is a verified user). For example, the memory system 310 may utilize the same seed when the secret key stored at the host system 305 is the same as the secret key stored at the memory system 310. That is, an unauthorized user or host system 305 may be unable to obtain the secret key stored at the memory system 310. Thus, the unauthorized user or host system 305 may be unable to generate the same output value (e.g., the access value) even if the same randomization process is utilized because the seed used at the memory system 310 and the unauthorized host system 305 is different. In some examples, the memory system 310 may generate the third value with a relatively low latency.

In some examples, the third value may be associated with (e.g., representative of, generated according to) a set of one or more identifiers of one or more host systems that are authorized to access the requested address range, the requested type of data, or both. In such cases, the access value transmitted with the access command may include an identifier associated with the host system 305.

At 345, the memory system 310 may perform the verification procedure to determine whether to permit or prohibit the requested access to the data. For example, the memory system 310 may validate the access value by comparing the access value received from the host system 305 with the third value (e.g., authorization code) generated by the memory system 310. The memory system 310 may validate that the access command received is from an authorized user if the access value matches the third value. That is, the memory system 310 may determine the host system 305 stores the same secret key based on the access value matching the third value. In some examples, constant time may be enabled for the verification procedure. For example, an execution time of the verification procedure, as well as one or more resources used by the verification procedure, may be independent of whether the verification procedure results in validation of the access command or invalidation of the access command. The execution time and resources used may be constant, in some examples, each time the verification procedure is run, which may improve security and reduce a probability of malicious attacks.

At 350, in some examples, the memory system 310 may execute the access command for the target address range if the host system 305 is validated as an authorized user. For example, the memory system 310 may read data, write data, or otherwise modify data within the target address range in response to the access command based on the host system 305 being validated as an authorized user. That is, if the access value matches the third value generated by the memory system 310 for the given address range, the memory system 310 may execute the access command.

At 355, if access value does not match the third value, the verification of the host system 305 may fail. That is, the host system 305 may not be validated as an authorized user of the memory system 310. In such cases, the memory system 310 may refrain from executing the access command and may not permit access by the host system 305.

At 360, the memory system 310 may transmit second data to the host system 305 in response to the access command. If the host system 305 is validated as an authorized user, the second data may be read data, write data, metadata, or any combination thereof retrieved from one or more memory arrays within the memory system 310 in response to the access command (e.g., from the indicated address range to which the host system 305 is authorized to access).

If the host system 305 is not validated as an authorized user, the second data may be invalid data. For example, the second data may include random data, poisoned data (e.g., data retrieved from the target address range and then poisoned or otherwise invalidated or corrupted), or some other invalid data.

At 365, the memory system 310 may transmit metadata to the host system 305. As described herein, if the verification procedure for the access command fails, the metadata may indicate that the data is invalid data. For example, one or more bits in the metadata may be set to a value reserved as an invalid data indication. Additionally, or alternatively, the value of the metadata may indicate that the verification procedure of the access command failed. For example, the metadata may indicate that the access key was invalid, or that some other error occurred during the verification. In some examples, the metadata may indicate whether the data sent at 360 includes randomized data or poisoned data. In some examples, the metadata may indicate that the verification failed for a certain type of data, for a certain region of the memory system 310, or both. The metadata may thereby be repurposed to indicate information associated with an invalid request.

The host system 305 may receive the metadata identifying that the data is invalid and may determine to discard the data, or perform one or more other operations based on the metadata. For example, the host system 305 may update a hash function, adjust an address range or a data type to which the host system 305 requests access, re-attempt authorization with the memory system 310, or the like based on the failed access attempt. The metadata may thereby provide information that the host system 305 may use to identify a failed attempt faster and take corrective actions as compared with systems in which the host system 305 receives invalid data without any indication.

In some examples, the metadata may be retrieved from the one or more memory devices within the memory system 310. For example, in response to the access command and while verifying the access value, the memory system 310 may retrieve or otherwise access data at the requested address range, along with associated metadata. If the verification fails, the metadata may be sent and the data may be scrambled, poisoned, or otherwise invalidated before transmission to the host system 305. Additionally, or alternatively, the memory system 310 (e.g., the error correction component 265, the access authorization component 215, or some other central circuitry) may refrain from accessing the memory devices until (e.g., unless) the request is verified. Instead, the data may be a randomized sequence of data and the metadata may be retrieved from one or more other memory locations or otherwise generated by the memory system 310 without accessing the memory devices, which may reduce latency and processing. The described techniques may thereby provide for improved verification and access control without transferring data over an internal bus within the memory system 310, which may further improve security and reliability.

If the verification of the access value succeeds, the memory system 310 may transmit the metadata to convey one or more other types of information, such as ECC information associated with the data, location information associated with the data, or the like. In such cases, the metadata may be set to one or more other values separate from the value reserved for verification failure indications.

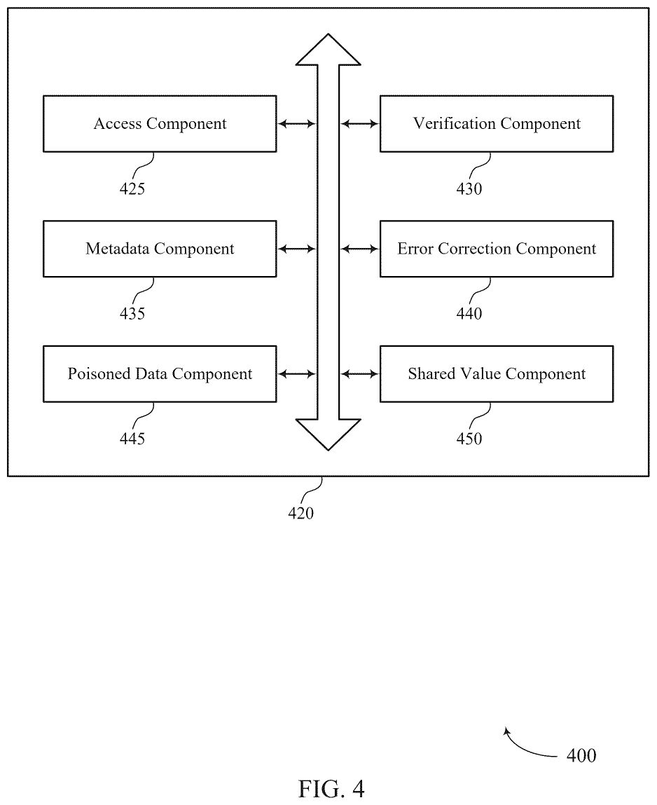

FIG. 4 shows a block diagram 400 of a memory system 420 that supports metadata for indication of access authorization in a memory system in accordance with examples as disclosed herein. The memory system 420 may be an example of aspects of a memory system as described with reference to FIGS. 1 through 3. The memory system 420, or various components thereof, may be an example of means for performing various aspects of metadata for indication of access authorization in a memory system as described herein. For example, the memory system 420 may include an access component 425, a verification component 430, a metadata component 435, an error correction component 440, a poisoned data component 445, a shared value component 450, or any combination thereof. Each of these components, or components of subcomponents thereof (e.g., one or more processors, one or more memories), may communicate, directly or indirectly, with one another (e.g., via one or more buses).

The access component 425 may be configured as or otherwise support a means for receiving a command to access, by a host system, data stored in the memory system, the command including an access value associated with accessing an address range of the data stored in the memory system. The verification component 430 may be configured as or otherwise support a means for verifying, in accordance with a verification procedure associated with determining whether to permit or prohibit the access to the data, the access value based at least in part on one or more shared values associated with the address range. The metadata component 435 may be configured as or otherwise support a means for transmitting metadata associated with the data, where the metadata indicates that the access, by the host system, to the data is prohibited based at least in part on the verification procedure.

In some examples, to support verifying the access value, the error correction component 440 may be configured as or otherwise support a means for verifying, by an error correction component of the memory system, the access value, where the error correction component is coupled with a plurality of memory devices within the memory system.

In some examples, the verification component 430 may be configured as or otherwise support a means for generating an authorization code associated with the address range of the data based at least in part on the one or more shared values. In some examples, the verification component 430 may be configured as or otherwise support a means for comparing the access value with the authorization code, where verifying the access value is based at least in part on comparing the access value with the authorization code.

In some examples, the poisoned data component 445 may be configured as or otherwise support a means for transmitting, based at least in part on the verification procedure, second data including poisoned data, where the metadata indicates that the second data includes the poisoned data based at least in part on determining, in accordance with the verification procedure, that the access to the data by the host system is prohibited.

In some examples, the access component 425 may be configured as or otherwise support a means for refraining from accessing the data stored at the address range in the memory system based at least in part on the access, by the host system, to the data being prohibited, where transmitting the second data is based at least in part on refraining from accessing the data stored at the address range.

In some examples, the metadata includes a plurality of bits associated with a plurality of candidate metadata values. In some examples, a value of the metadata includes a reserved value, from the plurality of candidate metadata values, that indicates the access, by the host system, to the data is prohibited based at least in part on the verification procedure.

In some examples, the metadata component 435 may be configured as or otherwise support a means for retrieving, from a storage location of the memory system that is external to one or more memory arrays within the memory system, the metadata based at least in part on the verification procedure. In some examples, the metadata component 435 may be configured as or otherwise support a means for concatenating the metadata with poisoned data based at least in part on the verification procedure, where transmitting the metadata includes transmitting the metadata and the poisoned data.

In some examples, to support verifying the access value, the verification component 430 may be configured as or otherwise support a means for comparing the access value to an authorization code associated with one or more identifiers of one or more host systems that are authorized to access the address range.

In some examples, the access component 425 may be configured as or otherwise support a means for receiving a second command to access, by a second host system, the data, the second command including a second access value. In some examples, the verification component 430 may be configured as or otherwise support a means for verifying, as part of a second verification procedure, the second access value based at least in part on the one or more shared values. In some examples, the metadata component 435 may be configured as or otherwise support a means for transmitting second metadata associated with the data, the second metadata indicating that the access, by the second host system, to the data is permitted based at least in part on the second verification procedure.

In some examples, the access component 425 may be configured as or otherwise support a means for retrieving the data from one or more memory arrays within the memory system in accordance with the address range and based at least in part on determining, in accordance with the verification procedure, that the second host system is authorized to access the data. In some examples, the metadata component 435 may be configured as or otherwise support a means for transmitting the data with the second metadata based at least in part on retrieving the data.

In some examples, the shared value component 450 may be configured as or otherwise support a means for retrieving, from a storage location within the memory system, the one or more shared values based at least in part on the address range indicated via the command. In some examples, the verification component 430 may be configured as or otherwise support a means for generating a verification key, an authorization code, a signature, or any combination thereof based at least in part on the one or more shared values and the address range. In some examples, the verification component 430 may be configured as or otherwise support a means for comparing the access value with the verification key, the authorization code, the signature, or any combination thereof, where verifying the access value is based at least in part on the comparing.

In some examples, the access component 425 may be configured as or otherwise support a means for transmitting, to the host system, a first value associated with access to the address range. In some examples, the verification component 430 may be configured as or otherwise support a means for performing, based at least in part on the first value and the one or more shared values, a randomization process to generate an output value. In some examples, the verification component 430 may be configured as or otherwise support a means for comparing the access value indicated via the command with the output value of the randomization process, where verifying the access value is based at least in part on the comparing.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

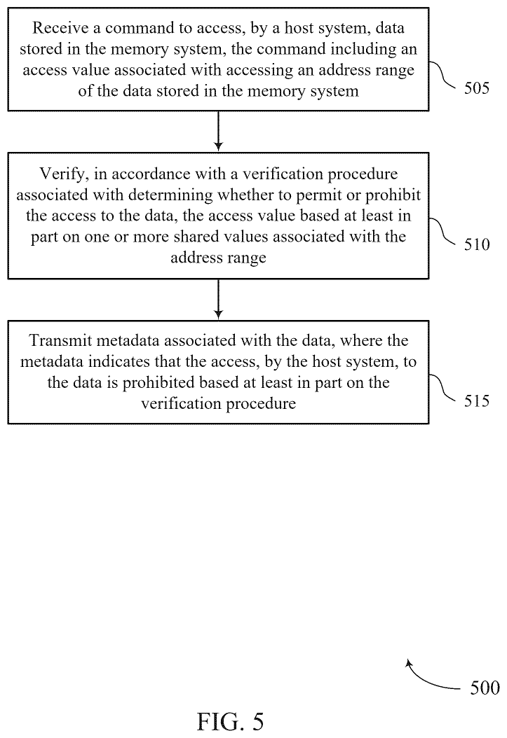

FIG. 5 shows a flowchart illustrating a method 500 that supports metadata for indication of access authorization in a memory system in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving a command to access, by a host system, data stored in the memory system, the command including an access value associated with accessing an address range of the data stored in the memory system. In some examples, aspects of the operations of 505 may be performed by an access component 425 as described with reference to FIG. 4.

At 510, the method may include verifying, in accordance with a verification procedure associated with determining whether to permit or prohibit the access to the data, the access value based at least in part on one or more shared values associated with the address range. In some examples, aspects of the operations of 510 may be performed by a verification component 430 as described with reference to FIG. 4.

At 515, the method may include transmitting metadata associated with the data, where the metadata indicates that the access, by the host system, to the data is prohibited based at least in part on the verification procedure. In some examples, aspects of the operations of 515 may be performed by a metadata component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for receiving a command to access, by a host system, data stored in the memory system, the command including an access value associated with accessing an address range of the data stored in the memory system; verifying, in accordance with a verification procedure associated with determining whether to permit or prohibit the access to the data, the access value based at least in part on one or more shared values associated with the address range; and transmitting metadata associated with the data, where the metadata indicates that the access, by the host system, to the data is prohibited based at least in part on the verification procedure.
Aspect 2: The method, apparatus, or non-transitory computer-readable medium of aspect 1, where verifying the access value includes operations, features, circuitry, logic, means, or instructions, or any combination thereof for verifying, by an error correction component of the memory system, the access value, where the error correction component is coupled with a plurality of memory devices within the memory system.
Aspect 3: The method, apparatus, or non-transitory computer-readable medium of any of aspects 1 through 2, further including operations, features, circuitry, logic, means, or instructions, or any combination thereof for generating an authorization code associated with the address range of the data based at least in part on the one or more shared values and comparing the access value with the authorization code, where verifying the access value is based at least in part on comparing the access value with the authorization code.
Aspect 4: The method, apparatus, or non-transitory computer-readable medium of any of aspects 1 through 3, further including operations, features, circuitry, logic, means, or instructions, or any combination thereof for transmitting, based at least in part on the verification procedure, second data including poisoned data, where the metadata indicates that the second data includes the poisoned data based at least in part on determining, in accordance with the verification procedure, that the access to the data by the host system is prohibited.
Aspect 5: The method, apparatus, or non-transitory computer-readable medium of aspect 4, further including operations, features, circuitry, logic, means, or instructions, or any combination thereof for refraining from accessing the data stored at the address range in the memory system based at least in part on the access, by the host system, to the data being prohibited, where transmitting the second data is based at least in part on refraining from accessing the data stored at the address range.
Aspect 6: The method, apparatus, or non-transitory computer-readable medium of any of aspects 1 through 5, where the metadata includes a plurality of bits associated with a plurality of candidate metadata values and a value of the metadata includes a reserved value, from the plurality of candidate metadata values, that indicates the access, by the host system, to the data is prohibited based at least in part on the verification procedure.
Aspect 7: The method, apparatus, or non-transitory computer-readable medium of any of aspects 1 through 6, further including operations, features, circuitry, logic, means, or instructions, or any combination thereof for retrieving, from a storage location of the memory system that is external to one or more memory arrays within the memory system, the metadata based at least in part on the verification procedure and concatenating the metadata with poisoned data based at least in part on the verification procedure, where transmitting the metadata includes transmitting the metadata and the poisoned data.
Aspect 8: The method, apparatus, or non-transitory computer-readable medium of any of aspects 1 through 7, where verifying the access value includes operations, features, circuitry, logic, means, or instructions, or any combination thereof for comparing the access value to an authorization code associated with one or more identifiers of one or more host systems that are authorized to access the address range.
Aspect 9: The method, apparatus, or non-transitory computer-readable medium of any of aspects 1 through 8, further including operations, features, circuitry, logic, means, or instructions, or any combination thereof for receiving a second command to access, by a second host system, the data, the second command including a second access value; verifying, as part of a second verification procedure, the second access value based at least in part on the one or more shared values; and transmitting second metadata associated with the data, the second metadata indicating that the access, by the second host system, to the data is permitted based at least in part on the second verification procedure.
Aspect 10: The method, apparatus, or non-transitory computer-readable medium of aspect 9, further including operations, features, circuitry, logic, means, or instructions, or any combination thereof for retrieving the data from one or more memory arrays within the memory system in accordance with the address range and based at least in part on determining, in accordance with the verification procedure, that the second host system is authorized to access the data and transmitting the data with the second metadata based at least in part on retrieving the data.
Aspect 11: The method, apparatus, or non-transitory computer-readable medium of any of aspects 1 through 10, further including operations, features, circuitry, logic, means, or instructions, or any combination thereof for retrieving, from a storage location within the memory system, the one or more shared values based at least in part on the address range indicated via the command; generating a verification key, an authorization code, a signature, or any combination thereof based at least in part on the one or more shared values and the address range; and comparing the access value with the verification key, the authorization code, the signature, or any combination thereof, where verifying the access value is based at least in part on the comparing.
Aspect 12: The method, apparatus, or non-transitory computer-readable medium of any of aspects 1 through 11, further including operations, features, circuitry, logic, means, or instructions, or any combination thereof for transmitting, to the host system, a first value associated with access to the address range; performing, based at least in part on the first value and the one or more shared values, a randomization process to generate an output value; and comparing the access value indicated via the command with the output value of the randomization process, where verifying the access value is based at least in part on the comparing.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component may initiate a change that allows signals to flow between the other components over a conductive path that previously did not permit signals to flow.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code, data, or both) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memories storing processor-executable code; and
one or more processors coupled with the one or more memories and individually or collectively operable to execute the code to cause the memory system to:
receive a command to access, by a host system, data stored in the memory system, the command comprising an access value associated with accessing an address range of the data stored in the memory system;
verify, in accordance with a verification procedure associated with determining whether to permit or prohibit the access to the data, the access value based at least in part on one or more shared values associated with the address range; and
transmit metadata associated with the data, wherein the metadata indicates that the access, by the host system, to the data is prohibited based at least in part on the verification procedure.

2. The memory system of claim 1, wherein, to verify the access value, the one or more processors are individually or collectively operable to execute the code to cause the memory system to:
verify, by an error correction component of the memory system, the access value, wherein the error correction component is coupled with a plurality of memory devices within the memory system.

3. The memory system of claim 1, wherein the one or more processors are individually or collectively further operable to execute the code to cause the memory system to:
generate an authorization code associated with the address range of the data based at least in part on the one or more shared values; and
compare the access value with the authorization code, wherein verifying the access value is based at least in part on comparing the access value with the authorization code.

4. The memory system of claim 1, wherein the one or more processors are individually or collectively further operable to execute the code to cause the memory system to:
transmit, based at least in part on the verification procedure, second data comprising poisoned data, wherein the metadata indicates that the second data comprises the poisoned data based at least in part on determining, in accordance with the verification procedure, that the access to the data by the host system is prohibited.

5. The memory system of claim 4, wherein the one or more processors are individually or collectively further operable to execute the code to cause the memory system to:
refrain from accessing the data stored at the address range in the memory system based at least in part on the access, by the host system, to the data being prohibited, wherein transmitting the second data is based at least in part on refraining from accessing the data stored at the address range.

6. The memory system of claim 1, wherein:
the metadata comprises a plurality of bits associated with a plurality of candidate metadata values; and
a value of the metadata comprises a reserved value, from the plurality of candidate metadata values, that indicates the access, by the host system, to the data is prohibited based at least in part on the verification procedure.

7. The memory system of claim 1, wherein the one or more processors are individually or collectively further operable to execute the code to cause the memory system to:
retrieve, from a storage location of the memory system that is external to one or more memory arrays within the memory system, the metadata based at least in part on the verification procedure; and
concatenate the metadata with poisoned data based at least in part on the verification procedure, wherein transmitting the metadata comprises transmitting the metadata and the poisoned data.

8. The memory system of claim 1, wherein, to verify the access value, the one or more processors are individually or collectively operable to execute the code to cause the memory system to:
compare the access value to an authorization code associated with one or more identifiers of one or more host systems that are authorized to access the address range.

9. The memory system of claim 1, wherein the one or more processors are individually or collectively further operable to execute the code to cause the memory system to:
receive a second command to access, by a second host system, the data, the second command comprising a second access value;
verify, as part of a second verification procedure, the second access value based at least in part on the one or more shared values; and
transmit second metadata associated with the data, the second metadata indicating that the access, by the second host system, to the data is permitted based at least in part on the second verification procedure.

10. The memory system of claim 9, wherein the one or more processors are individually or collectively further operable to execute the code to cause the memory system to:
retrieve the data from one or more memory arrays within the memory system in accordance with the address range and based at least in part on determining, in accordance with the verification procedure, that the second host system is authorized to access the data; and
transmit the data with the second metadata based at least in part on retrieving the data.

11. The memory system of claim 1, wherein the one or more processors are individually or collectively further operable to execute the code to cause the memory system to:
retrieve, from a storage location within the memory system, the one or more shared values based at least in part on the address range indicated via the command;
generate a verification key, an authorization code, a signature, or any combination thereof based at least in part on the one or more shared values and the address range; and
compare the access value with the verification key, the authorization code, the signature, or any combination thereof, wherein verifying the access value is based at least in part on the comparing.

12. The memory system of claim 1, wherein the one or more processors are individually or collectively further operable to execute the code to cause the memory system to:
transmit, to the host system, a first value associated with access to the address range;
perform, based at least in part on the first value and the one or more shared values, a randomization process to generate an output value; and
compare the access value indicated via the command with the output value of the randomization process, wherein verifying the access value is based at least in part on the comparing.

13. A method by a memory system, comprising:
receiving a command to access, by a host system, data stored in the memory system, the command comprising an access value associated with accessing an address range of the data stored in the memory system;
verifying, in accordance with a verification procedure associated with determining whether to permit or prohibit the access to the data, the access value based at least in part on one or more shared values associated with the address range; and
transmitting metadata associated with the data, wherein the metadata indicates that the access, by the host system, to the data is prohibited based at least in part on the verification procedure.

14. The method of claim 13, wherein verifying the access value comprises:
verifying, by an error correction component of the memory system, the access value, wherein the error correction component is coupled with a plurality of memory devices within the memory system.

15. The method of claim 13, further comprising:
generating an authorization code associated with the address range of the data based at least in part on the one or more shared values; and
comparing the access value with the authorization code, wherein verifying the access value is based at least in part on comparing the access value with the authorization code.

16. The method of claim 13, further comprising:
transmitting, based at least in part on the verification procedure, second data comprising poisoned data, wherein the metadata indicates that the second data comprises the poisoned data based at least in part on determining, in accordance with the verification procedure, that the access to the data by the host system is prohibited.

17. The method of claim 16, further comprising:
refraining from accessing the data stored at the address range in the memory system based at least in part on the access, by the host system, to the data being prohibited, wherein transmitting the second data is based at least in part on refraining from accessing the data stored at the address range.

18. The method of claim 13, wherein:
the metadata comprises a plurality of bits associated with a plurality of candidate metadata values; and
a value of the metadata comprises a reserved value, from the plurality of candidate metadata values, that indicates the access, by the host system, to the data is prohibited based at least in part on the verification procedure.

19. The method of claim 13, further comprising:
retrieving, from a storage location of the memory system that is external to one or more memory arrays within the memory system, the metadata based at least in part on the verification procedure; and
concatenating the metadata with poisoned data based at least in part on the verification procedure, wherein transmitting the metadata comprises transmitting the metadata and the poisoned data.

20. The method of claim 13, wherein the access value comprises an identifier associated with the host system, and wherein verifying the access value comprises:
comparing the access value to an authorization code associated with one or more identifiers of one or more host systems that are authorized to access the address range.

21. The method of claim 13, further comprising:
receiving a second command to access, by a second host system, the data, the second command comprising a second access value;
verifying, as part of a second verification procedure, the second access value based at least in part on the one or more shared values; and
transmitting second metadata associated with the data, the second metadata indicating that the access, by the second host system, to the data is permitted based at least in part on the second verification procedure.

22. The method of claim 21, further comprising:
retrieving the data from one or more memory arrays within the memory system in accordance with the address range and based at least in part on determining, in accordance with the verification procedure, that the second host system is authorized to access the data; and
transmitting the data with the second metadata based at least in part on retrieving the data.

23. The method of claim 13, further comprising:
retrieving, from a storage location within the memory system, the one or more shared values based at least in part on the address range indicated via the command;
generating a verification key, an authorization code, a signature, or any combination thereof based at least in part on the one or more shared values and the address range; and
comparing the access value with the verification key, the authorization code, the signature, or any combination thereof, wherein verifying the access value is based at least in part on the comparing.

24. The method of claim 13, further comprising:
transmitting, to the host system, a first value associated with access to the address range;
performing, based at least in part on the first value and the one or more shared values, a randomization process to generate an output value; and
comparing the access value indicated via the command with the output value of the randomization process, wherein verifying the access value is based at least in part on the comparing.

25. A non-transitory computer-readable medium storing code, the code comprising instructions executable by one or more processors to:
receive a command to access, by a host system, data stored in a memory system, the command comprising an access value associated with accessing an address range of the data stored in the memory system;
verify, in accordance with a verification procedure associated with determining whether to permit or prohibit the access to the data, the access value based at least in part on one or more shared values associated with the address range; and
transmit metadata associated with the data, wherein the metadata indicates that the access, by the host system, to the data is prohibited based at least in part on the verification procedure.
